(19) United States
(12) Patent Application Publication
(10) Pub. No.: US 2002/0178761 A1
(43) Pub. Date: Dec. 5, 2002

(54) Method of low PMD optical fiber manufacture

(76) Inventors: Jill A. Cummings, Castle Hayne, NC (US); Douglas G. Neilson, Wilmington, NC (US)

Correspondence Address: CORNING INCORPORATED, SP-TI-3-1, CORNING, NY, 14831

(21) Appl. No.: 10/156,897

(22) Filed: May 29, 2002

Related U.S. Application Data
(60) Provisional application No. 60/295,218, filed on May 31, 2001.

(51) Int. Cl. C03B 37/018; C03B 37/027

(52) U.S. Cl. 65/417; 65/419; 65/435

(57) ABSTRACT

A method of fabricating an optical waveguide fiber from a preform having a centerline hole which includes pressurizing and expanding the centerline hole to improve uniformity, circularity, and/or symmetry of hole closure in order to achieve low levels of polarization mode dispersion in the fiber.

### BACKGROUND OF THE INVENTION

1. Field of the Invention

The present invention relates generally to the field of optical waveguide fibers, and more particularly to methods of making low polarization-mode dispersion optical waveguide fibers.

2. Technical Background

A significant goal of the telecommunications industry is to transmit greater amounts of information, over longer distances, and in shorter periods of time. Typically, as the number of systems users and frequency of system use increase, demand for system resources increases as well. One way of meeting this demand is by increasing the bandwidth of the medium used to carry the information. In optical telecommunication systems, the demand for optical waveguide fibers having increased bandwidth is particularly high.

In the manufacture of an optical fiber, a variety of methods can be used to deposit the various soot layers. In the outside vapor deposition (“OVD”) process, the soot core blank is formed by depositing soot formed from precursors containing, for example, silica and germanium constituents onto a substrate, such as a mandrel, or a target rod, typically a ceramic bait rod. As the bait rod is rotated, the precursor constituents are delivered to the flame burner along with oxygen to produce soot, and that soot is then deposited onto the bait rod. The soot may be a combination of silica and doped silica soot. Once sufficient soot is deposited, the bait rod is removed, and the resultant soot core blank can be consolidated into a fused silica preform such as a core rod preform or core cane preform or cane preform or glass core blank. The soot core blank is typically consolidated by hanging or lowering the soot core blank in a consolidation furnace and heating the soot core blank to a temperature and for a time sufficient to consolidate the soot core blank into a glassy preform. Preferably, prior to the consolidating step, the soot core blank is chemically dried, for example, by exposing the soot core blank to chlorine gas at an elevated temperature. The result is a generally cylindrical glass core blank or glass cane preform having an axial hole along its centerline, or centerline hole. That is, the generally cylindrical consolidated glass tube has a centerline hole. Typically, the glass core blank or glass cane preform has a length of about 0.5 m to 1.0 m, with an inside diameter of about 0.5 to about 3.0 cm, and an outside diameter of about 3 to 8 cm. Although these dimensions vary according to process and product requirements, various sizes and even shapes of glass core blank or glass cane preform can benefit from the present invention as set forth hereinbelow.

The glass core blank or glass cane preform is then typically drawn, e.g., by positioning the glass core blank in a furnace, heating the core blank to a temperature of approximately 2000° C., and then redrawing or pulling or stretching the core blank into a smaller diameter core cane. The thermal energy softens the glassy blank or preform which, in tandem with pulling on the preform, results in a necking down of the preform, i.e. necking of both the outer diameter and the inner diameter. In a vertical redraw process, the glass core blank or glass core preform is steadily lowered into the hot zone of a furnace while the end of the preform that has already passed through the heated region is simultaneously and steadily pulled.

During the redraw operation, the centerline hole of the core blank is typically collapsed by applying considerable vacuum (e.g., a pressure of less than 0.25 atm) along the centerline hole. When the hole size is so large that relying on surface tension to close the hole becomes impractical, these vacuum forces ensure complete closure of the glass core blank along the centerline. Typically, drawing or pulling on the preform without the assistance of vacuum is insufficient to close or collapse the hole.

After the redraw step, the resulting core cane is then typically clad with one or more additional core soot layers and/or overclad with a layer of cladding by depositing a cladding soot thereon, e.g. via an OVD deposition process, or by inserting the core cane into the centerhole of a fused silica tube (rod-in-tube). Once covered with sufficient cladding soot, the resultant soot overclad core cane is chemically dried and consolidated to form an optical fiber preform. While different processes (e.g. MCVD and others) may employ somewhat different processes to form components employed in the manufacture of preforms, many of them (e.g. MCVD) commonly end up with a cylindrical tube or other intermediate glass object having a hole therein, which is closed prior to drawing fiber therefrom. These manufacturing processes typically involve utilizing a vacuum at some point during the manufacturing process to close the hole or gap which is present between glass constituents without changing the outer diameter significantly.

The use of a relatively strong vacuum to close the centerline and other holes in a glass core blank or other optical fiber preforms typically presents difficulties. Such vacuum forces can result in a non-symmetrical centerline profile of the cane, as shown, for example, in FIG. 1. The application of relatively strong vacuum to the centerline hole region can result in a noncircular collapse of the hole. FIG. 1 illustrates a cross section of core cane, indicated generally at 10, which includes a center point 12 surrounded by layers of glass 14. In FIG. 1, these glass layers 14 have an irregular, asymmetric shape, as a result of the application of the vacuum forces during redraw. Only at locations farther from the center point 12 do the layers of glass 16 begin to form more symmetrical and concentric circles or rings about the center point 12. The same or similar non-symmetrical layers of glass present in the core cane will be present when that cane is eventually drawn into an optical fiber. Views of the centerline profile taken at different locations along the length of the core cane (or the optical fiber resulting therefrom) would also show core asymmetry. Further, the geometrical properties of the core cane and resultant optical fiber may change along the length thereof. More specifically, the specific asymmetrical shape at one location along the optical fiber might differ from the shape at another location along the optical fiber.

Asymmetric core geometry is believed to be a key cause of polarization mode dispersion (PMD), a form of dispersion which results when one component of light travels faster than an orthogonal component. The occurrence of PMD which is present to any significant degree, especially in single mode fibers, is a severe detriment because PMD limits the data transmission rate of fiber-based telecommunications systems. Single mode fibers and multimode fibers typically both have an outside diameter of generally about 125 microns. However, single mode fibers have a relatively small core diameter, e.g., about 8 microns. Because of this dimensional relationship, single mode fibers are extremely sensitive to polarization mode dispersion brought on by non-symmetric hole closure caused during fiber manufacture. Consequently, reduced PMD is a significant goal in fiber manufacture, especially in single mode fibers. In contrast to the small core size of single mode fibers, the core region of a multimode fiber commonly typically has a diameter of 62.5 microns or 50 microns. PMD is also deleterious in multimode fibers. In multimode fibers, non-symmetric hole closure has resulted in the inability to tune refractive index profiles on the innermost portion of the fiber adjacent the centerline. As a result, lasers used to launch light into such fibers are often offset some distance from the centerline of the multimode fiber to avoid this region of non-symmetric hole geometry. Thus, both single mode and multimode fibers could benefit from lowered PMD.

PMD may be reduced by spinning of the optical fiber during the fiber draw operation, wherein the fiber is mechanically twisted along its centerline axis while being drawn from the molten root of the optical fiber preform or blank. This twisting enables orthogonal components of light to couple to each other, thus averaging their dispersion and lowering PMD. Although spinning can mitigate the effects of non-symmetric hole closure, spinning is a fairly complicated process which can detract from an optical fiber and/or the manufacture thereof. For example, spinning can impede the speed at which fiber is drawn, cause coating geometry perturbations, reduce the strength of the optical fiber, and so forth.

Additionally, asymmetric core geometry can cause variations in core diameter along the length of the fiber core so that light transmitted through the fiber propagates through or “sees” a different core cross-sectional area at different points along the length of the optical fiber. In addition, an asymmetric centerline profile can reduce the bandwidth of laser launched multimode fiber.

The use of strong vacuum forces to close the centerline hole may also result in voids being formed along the centerline which can further impair the transmissive properties of the optical fiber.

As used herein, the term “preform” refers to any silica-based body used in the manufacture of optical waveguide fiber, whether containing silica soot or not, including but not limited to preforms also known as unconsolidated soot preforms, soot core preforms, soot core blanks, fused silica preforms, core rod preforms, core cane preforms, core blanks, glass core blanks, glass cane preforms, glassy preform, consolidated preform, and/or optical fiber preforms.

### SUMMARY OF THE INVENTION

A method of manufacturing an optical fiber or a preform for forming an optical fiber is disclosed herein. The method comprises providing a silica-based preform having an outer surface with an outside diameter and an inner surface with an inside diameter, the inner surface defining a centerline hole therein, then heating at least a portion of the preform so that at least part of the preform reaches a temperature greater than or equal to its consolidation temperature, and then pressurizing the centerline hole to a positive pressure with respect to the pressure at the outer surface of the preform by introducing at least one gas into the centerline hole sufficient to expand the inside diameter of the preform at or near the at least part of the preform while the at least part of the preform is greater than or equal to its consolidation temperature, thereby radially expanding at least part of the centerline hole. The outside diameter of the preform will generally expand along with the corresponding expansion of the centerline hole.

In a preferred embodiment, the at least a portion of the preform is heated to a temperature greater than or equal to its consolidation temperature and less than its drawing temperature. In some preferred embodiments, the at least part of the preform reaches a temperature in the range of about 1450 C. to about 1950 C. In other preferred embodiments, the at least part of the preform reaches a temperature in the range of about 1500 C. to about 1600 C. In still other preferred embodiments, substantially all of the preform is heated simultaneously.

In some preferred embodiments, the at least a portion of the preform is heated while the centerline hole is being pressurized. In other preferred embodiments, the at least a portion of the preform is not being heated while the centerline hole is being pressurized. In still other preferred embodiments, the centerline hole is pressurized after the at least a portion of the preform is heated, particularly where the at least a portion of the preform retains a high enough temperature to permit expansion of that section of the preform and the centerline hole.

The method may further preferably comprise contracting the centerline hole after the centerline hole is pressurized. The centerline hole may preferably at least partially contract, or the centerline hole may fully collapse. Contraction and/or collapse of the centerline hole may preferably be assisted or effected by evacuating the centerline hole. In some embodiments, the centerline hole may preferably be evacuated without pulling on the preform. In other embodiments, at least one end of the preform may preferably be pulled.

In preferred embodiments, the centerline hole is contracted and/or collapsed without a positive pressure inside the centerline hole with respect to the outside surface of the preform.

In some preferred embodiments, core cane is drawn from the preform. In other preferred embodiments, optical fiber is drawn from the preform.

The method may further preferably comprise simultaneously evacuating the centerline hole and pulling on at least one end of the preform. Alternatively, the method may further preferably comprise pulling on at least one end of the preform while the pressure in the centerline hole is at or near the pressure at the outer surface of the preform, where surface tension forces are relied upon for final collapse of the centerline hole.

The preform may preferably be dried prior to or during consolidation, or both prior to and during consolidation. During drying, the preform may be preferably exposed to at least one drying gas. The preform may also preferably be exposed to an inert gas as well as at least one drying gas. In a preferred embodiment, the preform is exposed to a mixture of chlorine and helium.

In one embodiment of the method disclosed herein, the pressure inside the centerline hole is preferably increased by greater than about 0.1 atm above the pressure at the outer surface of the preform.

In another embodiment, the pressure inside the centerline hole is preferably increased by greater than about 0.25 atm above the pressure at the outer surface of the preform.

In still another embodiment, the pressure inside the centerline hole is preferably increased by greater than about 0.5 atm above the pressure at the outer surface of the preform.

In yet another embodiment, the pressure inside the centerline hole is increased by greater than about 1.0 atm above the pressure at the outer surface of the preform.

The centerline hole may preferably be pressurized for a time sufficient to achieve a desired level of polarization mode dispersion in a fiber drawn from the preform.

In one embodiment of the method disclosed herein, the centerline hole is preferably pressurized for up to 0.1 hours. In another embodiment, the centerline hole is preferably pressurized for up to 0.5 hours. In yet another embodiment, the centerline hole is preferably pressurized for up to 1.0 hours. In still another embodiment, the centerline hole is preferably pressurized for up to 1.5 hours. In yet another embodiment, the centerline hole is pressurized for greater than about 2.0 hours.

The method may further preferably comprise sealing at least one end of the centerline hole prior to pressurizing the centerline hole. A plug may be inserted into the one end of the centerline hole. The plug may be inserted before the heating step.

In preferred embodiments, the centerline hole is actively pressurized. The pressurization of the centerline hole may preferably be controlled, either with an open loop control system or a closed loop control system.

Preferably, the initially provided silica based preform comprises at least one of silica-based soot and consolidated glass. That is, the preform may comprise silica soot, consolidated glass, or both silica-based soot and consolidated glass.

In one embodiment, the initially provided silica based preform is preferably a soot preform. The soot preform typically is made primarily from silica-based soot, and may include a consolidated glass portion, such as a handle or protrusion to assist in handling and further processing.

In another embodiment, the initially provided silica based preform is preferably a core cane preform. The cane preform preferably comprises consolidated glass.

In still another embodiment, the initially provided silica based preform comprises a glass tube.

In another aspect, a method of manufacturing an optical fiber is disclosed herein comprising providing a silica-based preform having an outer surface with an outside diameter and an inner surface with an inside diameter, the inner surface defining a centerline hole therein, heating at least a portion of the preform so that at least part of the preform reaches a temperature in the range of about 1450 C. to about 1950 C., sealing at least one end of the centerline hole, pressurizing the centerline hole for a time and to a positive pressure with respect to the pressure at the outer surface of the preform by introducing at least one gas into the centerline hole sufficient to expand the inside diameter (and the outside diameter) of the preform at or near the at least part of the preform while the at least part of the preform is greater than or equal to its consolidation temperature, thereby radially expanding at least part of the centerline hole, collapsing the centerline hole while either relying solely on surface tension or surface tension and a vacuum, heating at least an end of the preform to a temperature greater than 1950 C., and drawing the optical fiber from the preform.

The method may further comprise applying at least one layer of silica-based material on the outer surface of the preform after collapsing the centerline hole. The method may also include consolidating the at least one layer before drawing the optical fiber.

In one preferred embodiment, a method for producing a cane preform is disclosed herein. The centerline hole is first pressurized, thereby enhancing the circularity in the region of the preform surrounding the centerline hole. Secondly, a vacuum is applied to the centerline hole to collapse or fully close the hole. The vacuum is preferably applied to hasten the closure process without undesirably distorting the circularity of the hole and/or the region therearound. The strength of the applied vacuum can be chosen to dominate the collapse or chosen to augment the surface tension forces.

In another preferred embodiment, the method disclosed herein may be implemented in the consolidation stage of preform and/or optical fiber manufacturing. Thus, after complete consolidation, the centerline hole region could be pressurized, for example using an inert gas, and the preform could be driven vertically downward through a heated section. The thermal energy that is imparted to the preform consolidates the soot preform into a softened glass with lowered viscosity, and enables the preform, or a portion thereof, to enlarge during pressurization, thereby circularizing the centerline hole region. Then, after the entire preform or blank has traversed through the heated section or sections, the centerline hole would be evacuated by application of a vacuum thereto, whereupon the now-consolidated preform could be driven downward again through the heated section to fully close or fully collapse the centerline hole. The strength of the applied vacuum can be chosen to dominate the collapse or chosen to augment the surface tension forces.

In yet another preferred embodiment, the pressurization of the centerline hole may be employed during a cane redraw stage.

Single mode fibers may be made in accordance with the method disclosed herein which exhibit low polarization mode dispersion without having to resort to or rely solely upon spinning or other PMD mitigation methods. In preferred embodiments, the amount of spin imparted to the optical fiber could be reduced compared to a similar optical fiber whose centerline region was not processed according to the method disclosed herein.

The method disclosed herein can also be used to form multimode optical fibers which are inherently better suited for use with laser sources. In laser light launching methods, the spot size of the laser can be small relative to the overall size of the core. If the laser is directed at an area having nonsymmetric glass layers, these non-symmetric glass layers can disturb the path along which the laser beam would otherwise travel. The method disclosed herein preferably enhances the concentricity of these layers. Furthermore, the method disclosed herein preferably aids in achieving uniformly symmetric and concentric glass layers about the centerline of the core of the fiber.

Moreover, an optical fiber produced in accordance with the method disclosed herein may have less voids along its centerline and/or proximate its centerline. It is believed that the effects of the expansion of the hole diameter due to the positive pressure treatment can help to reduce the likelihood of voids in the fiber, thereby reducing the light reflections and/or losses associated therewith.

These and other aspects of the invention will be further understood and appreciated by those skilled in the art by reference to the following written specification, claims, and appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of the specification. The drawings illustrate various embodiments of the invention, and together with the description serve to explain the principals and operation of the invention.

### BRIEF DESCRIPTION OF THE DRAWINGS

FIG. 1 is an exemplary schematic view of a centerline profile of a cross section of a generally cylindrical glassy body, such as a preform or an optical fiber, formed using a vacuum force during a redraw operation with a strong vacuum used to make a core cane;

FIG. 2 is a fragmentary perspective view of an optical waveguide fiber;

FIG. 3 is a fragmentary perspective view of a glass optical fiber preform;

FIG. 4 is a schematic view illustrating an outside vapor deposition process for making a soot core blank or a soot blank;

FIG. 5 is a vertical cross-sectional schematic view of a soot core blank located within a consolidation furnace;

FIG. 6 is a vertical cross-sectional schematic view of a preform with apparatus for both pressurizing and evacuating the centerline hole;

FIG. 7 is a vertical cross-sectional schematic view of a consolidated preform having a centerline hole about to enter into proximity with a hot zone of a furnace;

FIG. 8 is a vertical cross-sectional schematic view of a consolidated preform having a centerline hole being expanded by pressurization thereof;

FIG. 9 is a vertical cross-sectional schematic view of a consolidated preform having an expanded centerline hole which is in proximity to a plurality of heat zones in the furnace;

FIG. 10 is a vertical cross-sectional schematic view of a consolidated preform with an expanded centerline hole which is being collapsed in proximity to a heat zone in the furnace;

FIG. 11 is a vertical cross-sectional schematic view of a core cane being cut from a consolidated preform or glass core blank, the core cane having a centerline hole; and

FIG. 12 is a schematic view of a substantially symmetric centerline profile of a cross section of an optical waveguide fiber made in accordance with the present invention.

### DETAILED DESCRIPTION OF THE PREFERRED EMBODIMENT

Reference will now be made in detail to the present preferred embodiments of the method disclosed herein, examples of which are illustrated in the accompanying drawings. Wherever possible, the same reference numerals will be used throughout the drawings to refer to the same or like parts.

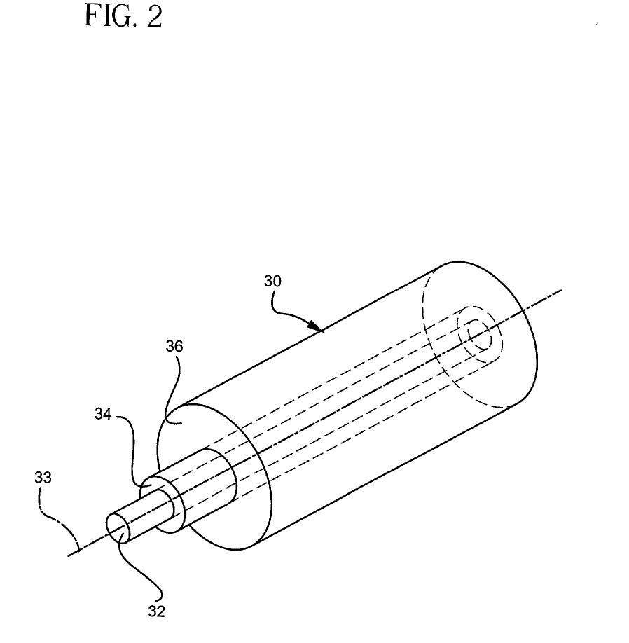

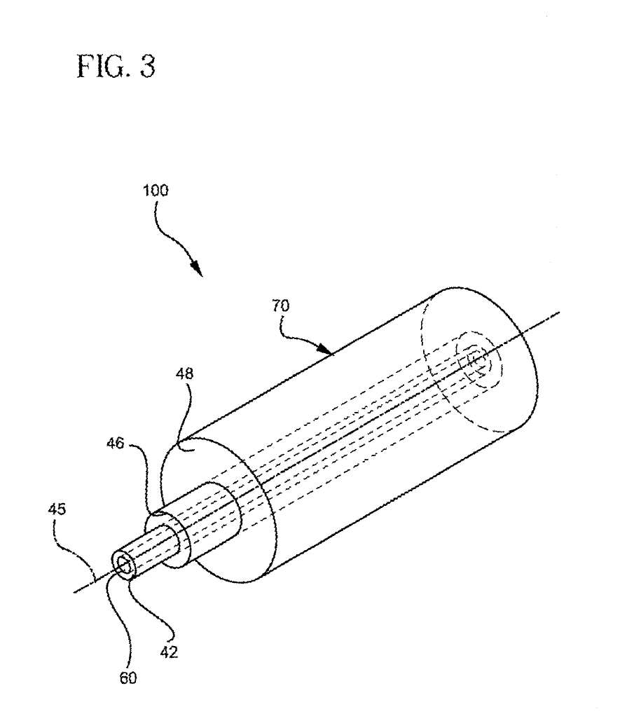

Referring initially to FIG. 2, an optical waveguide fiber 30 manufactured by the method disclosed herein is shown. The optical waveguide fiber includes a central core region 32 having a centrally located axis 33, an optional outer glass core region 34 and a coaxial cladding region 36. Optical waveguide fiber 30 is formed from silica-based preform 100 in the form of a cylindrical glass body or optical fiber preform 70 (FIG. 3) having a central core region 42 with a longitudinally extending, centrally located centerline hole 60 extending therethrough along a central longitudinal axis 45. Optical fiber preform 70 also includes an outer glass core region 46 and cladding region 48 both coaxial with core region 42. For example, central core region 32 and 42 could consist of germanium doped central region, and region 34 and 46 could consist of additional regions having various amounts of fluorine and/or germania dopants, to form a complex index of refraction profile (e.g., a segcor profile). Of course, the method disclosed herein is not limited to use with these dopants, nor is it limited to fibers having complex index of refraction profiles. For example, region 34 may be omitted, and the fiber may be a simple step index profile. Also, region 34 could include a so-called near clad region, which typically consists of pure silica.

Referring to FIG. 3, silica-based preform 100 in the form of soot core blank or soot preform 58 which is comprised at least partially of silica-based soot and which is subsequently processed into a cylindrical glass preform 70, is preferably formed by chemically reacting at least some of the constituents of a moving fluid mixture including at least one glass-forming precursor compound in an oxidizing medium to form a silica-based reaction product. At least a portion of this reaction product is directed toward a substrate to form a porous body.

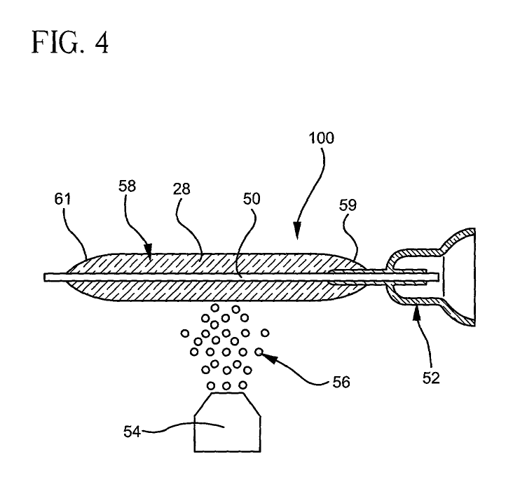

As illustrated in FIG. 4, the porous body may be formed, for example, by depositing layers of soot onto a bait rod via an outside vapor deposition (“OVD”) process. In FIG. 4, a bait rod or mandrel 50 is inserted through a tubular integral handle 52 and mounted on a lathe (not shown). The lathe is designed to rotate and translate mandrel 50 in close proximity with a soot-generating burner 54. As mandrel 50 is rotated and translated, silica-based reaction product 56, known generally as soot, is directed toward mandrel 50. The silica-based reaction product 56 can include pure silica and/or dopants. At least a portion of silica-based reaction product 56 is deposited on mandrel 50 and on a portion of integral handle 52 to form a silica-based preform 100 in the form of a cylindrical soot porous body or soot core blank 58 thereon having a proximal end 59 and a distal end 61. While this aspect of the method disclosed herein has been described in conjunction with a translating lathe, the skilled artisan will understand that soot-generating burner 54 can translate rather than the mandrel 50. Moreover, the method disclosed herein is not limited to soot deposition via an OVD process. Rather, other methods of chemically reacting at least some of the constituents of a moving fluid mixture, such as, but not limited to, liquid or vapor phase delivery of at least one glass-forming precursor compound in an oxidizing medium can be used to form the silica-based reaction product of the method disclosed herein. Moreover, other processes, such as the inside vapor deposition process (IV, or IVD), and modified chemical vapor deposition process (MCVD) are also applicable to the method disclosed herein. The method disclosed herein is most suitable for preparing to close, partially closing, and/or fully collapsing a centerline hole.

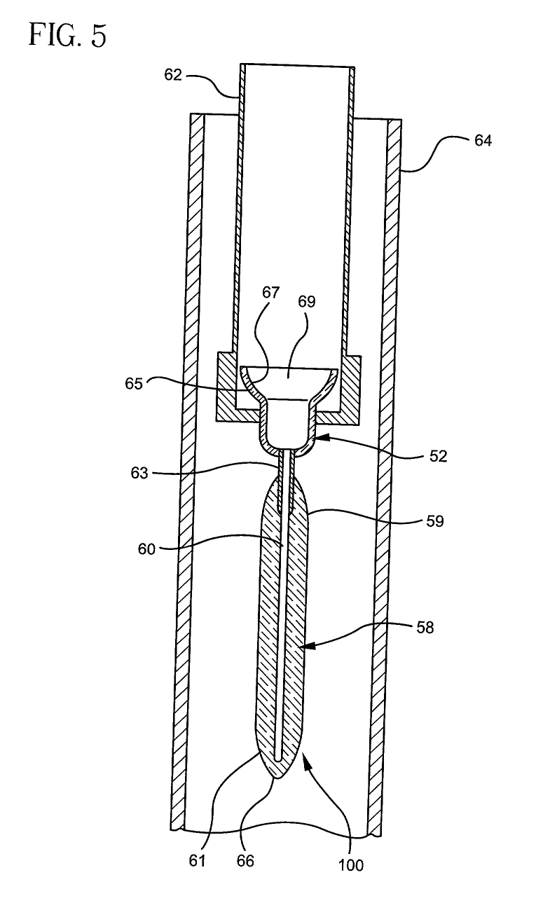

Referring to FIG. 5, once the desired quantity of soot has been deposited on mandrel 50, soot deposition is terminated and mandrel 50 is removed from soot core blank 58. Upon removal of mandrel 50, an inner surface of soot core blank 58 defines an axially extending void or centerline hole 60 (FIG. 5). Soot core blank 58 is vertically suspended within a consolidation furnace 64 by a downfeed handle 62 which engages integral handle 52. Consolidation furnace 64 preferably concentrically surrounds the soot core blank 58. Integral handle 52 is preferably formed of a silica based glass material and includes a first end 63 about which proximal end 59 of core blank 58 is formed, and a second end 65 defining an inner surface 67 therein. Alternatively, second end 65 of integral handle 52 may be flame worked thereon subsequent to the deposition and consolidation steps. Integral handle 52 is generally cup-shaped and defines an interior cavity 69. Inner surface 67 is preferably provided with a coarse texture, the significance of which is discussed below. Centerline hole 60 located near distal end 61 of soot core blank 58 is preferably fitted with a glass bottom plug 66 prior to positioning porous body 58 within consolidation furnace 64A. Glass plug 66 is preferably made from a relatively low melting point glass (e.g. lower than that of the soot core blank) so that during consolidation, as the soot of the soot core blank is consolidated into glass, the glass plug will effectively seal the end of the centerline hole. While inserting bottom plug 66 is the preferred method for sealing the distal end 61 of porous body 58, other methods and devices sufficient to seal or close distal end 61 to prohibit airflow therethrough may be employed, such as, but not limited to, flaming and/or crimping the end 61 shut.

In one aspect of the method disclosed herein, the centerline hole 60 at proximal end 59 of core blank 58 may remain open to ambient air or may be closed by inserting a top plug 73 into centerline hole 60 prior to the consolidation step similar to bottom plug 66. In one embodiment, to facilitate such plugging of the hole, the hole inside the integral handle is made larger than the hole inside the soot preform 58, and the size of plug 73 is selected to be intermediate these two internal diameters, so that the plug can be inserted through the integral handle portion 52, but lodges in the centerline hole region of preform 58. In an alternative embodiment, top plug 73 may consist of a thicker region (i.e. thick enough to plug the centerline hole 60 within the soot preform 58) at a bottom end which serves to plug the centerline hole 60 of soot preform 58, another thick region (i.e. thicker than the centerline hole in integral handle 52) at the top end of the plug to prevent the plug 73 from falling into the centerline hole 60 of soot preform 58, and an intermediate region between the two ends to connect these two thicker end regions. Thus the soot preform 58 may be consolidated while both ends of the centerline hole are sealed, yielding a consolidated glassy preform which may be immediately or subsequently processed.

In one aspect of the method disclosed herein, the silica-based preform 100 in the form of a soot core blank, or porous body, or soot preform 58 is preferably chemically dried, for example, by exposing soot core blank 58 to a chlorine containing atmosphere at an elevated temperature within consolidation furnace 64. The chlorine containing atmosphere effectively removes water and other impurities from soot core blank 58 which otherwise would have an undesirable effect on the properties of optical waveguide fiber manufactured from blank 58. In an OVD formed soot core blank 58, the chlorine flows sufficiently through the soot to effectively dry the entire blank 58, including the region surrounding centerline hole 60. Following the chemical drying step, the temperature of the furnace is elevated to a temperature sufficient to consolidate the soot into a consolidated preform, or glassy preform, or glass core blank 55.

In a preferred embodiment, the soot preform 58 traverses through a consolidation oven or furnace 64. The consolidation furnace 64 may have one or more heat zones. Thus, for example, the soot preform 58 may preferably be vertically lowered into consolidation furnace 64, wherein one end or tip of the soot preform 58 encounters a heat zone. As a portion of the soot preform 58 becomes heated, at least part of soot preform reaches a consolidation temperature. Alternatively, the entire heated portion of the soot preform 58 may reach a consolidation temperature therethroughout.

Preferably, consolidation temperatures for a silica-based soot preform typically lie in the range of 1450° C. to 1600° C., although the skilled artisan could readily determine the temperature(s) applicable to a soot preform of a particular composition.

In the preferred embodiment, the silica-based preform 100 in the form of soot preform 58 traverses at a desired rate, and/or the soot preform or a portion thereof is exposed to a temperature and for a time sufficient to consolidate at least part of the soot preform. Thus, the soot preform 58, or a fraction thereof, can be consolidated into a glassy preform or consolidated preform 55.

In an alternative preferred embodiment, the soot preform 58 (or a selected fraction thereof) may be placed in a consolidation furnace such that the entire soot preform, or the selected fraction thereof, is in its entirety, exposed to the heating effect of the consolidation furnace 64 at the same time, or more particularly, the entire preform or selected fraction thereof is simultaneously exposed to the heating effect of the hot zone or zones of the consolidation furnace. Thus, the entire soot preform 58 (or a selected fraction thereof) can be consolidated en masse into a glassy preform or consolidated preform 55.

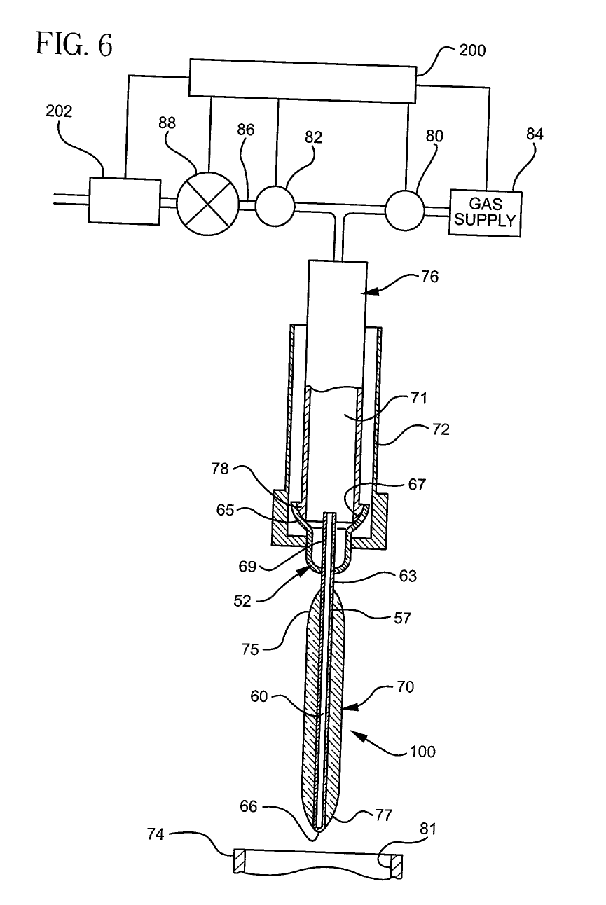

As seen in FIG. 6, in one preferred embodiment a cylindrical inner handle 76 has a lower end bowl-shaped, coarse textured mating surface 78 which forms a substantially airtight seal with mating surface 67 of integral handle 52. Positive or negative pressure may be applied to interior cavity 71 of inner handle 76 and interior cavity 69 of integral handle 52. Applying a negative pressure can assist in removing contaminants such as H₂O as well as other particulate matter therefrom. Centerline hole 60, interior cavity 71, and interior cavity 69 may be pressurized with a dry inert (e.g. helium) or drying (e.g. chlorine) gas or gases from at least one gas supply 84. The supply of dry or drying gases is preferably provided so that if any gas enters centerline hole 60 of glass preform 100, the gas is a clean dry gas, or a clean gas that promotes drying, that will not lead to attenuation induced losses within the resultant optical waveguide fiber. The gas supply 84 may include a pressurized gas source and/or a pump for delivering the pressurizing gas(es). Valve 80 may preferably provide on/off control of the flow of gases to and/or from gas supply 84.

Referring again to FIG. 6, controller 200 may be provided to control gas supply 84, which may include a gas pump, with an open loop control scheme or a closed loop feedback control scheme based upon one or more feedback signals of one or more appropriate control variables, e.g. a pressure signal from a pressure sensor located in a position to sense an appropriate pressure such as the centerline hole 60 or interior cavity 71, and/or one or more of the lines between gas supply 84, valve 80, and inner handle 76. Sensors are not shown in the drawings.

One or more dry or drying gas(es) may be introduced within inner handle 76 to maintain interior cavity 71 of inner handle 76, interior cavity 69 of integral handle 52, and centerline hole 60 of glass preform 70 free of contaminants, such as OH⁻ ions, and to prevent recontamination thereof. A valve 82 may be used to control the flow of gas from the gas supply 84 as well as the flow of gas to and from centerline hole 60, interior cavity 71, and interior cavity 69. Exhaust tube 86 may be connected to or coupled with a one-way valve 88 that prevents the entry of air into exhaust tube 86 which might otherwise result in the contamination of centerline 60 by ambient air and contaminant matter associated therewith. One-way valve 88 may be provided in the form of a bubbler, a check valve, or any other form of a one-way valve that prevents the backflow of ambient air into exhaust tube 86. Exhaust tube 86 may further be connected to vacuum pump or vacuum source 202 which is preferably provided to evacuate the centerline hole 60. Valve 82 and/or vacuum pump 202 may be controlled by controller 202, either by an open loop control scheme or closed feedback loop control scheme. Sensors and their connections between valve 82 and/or vacuum 202 are not shown in the drawings.

In accordance with the method disclosed herein, the centerline hole 60 is pressurized. Preferably, the centerline hole 60 of preform 100 is actively pressurized by introducing at least one gas into the centerline hole 60. The gas(es) are preferably inert dry gases, such as helium, or drying gases, such as chlorine. The centerline hole 60 is pressurized to a positive pressure with respect to the pressure at the outer surface of the preform 100, and for a time, sufficient to expand the inside diameter of the preform 100 wherever the preform is greater than or equal to its consolidation temperature, thereby radially expanding the centerline hole 60 thereat. Thus, if at least part of the preform 100 is greater than or equal to its consolidation temperature, then at least part of the centerline hole 60 would radially expand with sufficient pressurization. The outside diameter of the preform 58 would also typically expand in proximity to wherever the inside diameter expands.

Preferably, the active gas pressurization of the centerline hole 60 is controlled. For example, gas flow rates, pressures, durations, and/or schedules may be regulated, either via closed loop feedback or open loop control schemes.

In preferred embodiments, the preform 100 is preferably a silica based preform 58 comprised of silica-based soot, or substantially comprised of silica-based soot. The preform 58 may also preferably comprise previously consolidated glass. In one preferred embodiment, the preform 58 comprises a glass tube 48. The preform 58 may also preferably comprise silica-based soot as well as previously consolidated glass. The preform 58 may also preferably be substantially comprised of previously consolidated glass. The preform 70 may also consist entirely of consolidated glass.

Thus, whether a particular transverse cross-section of the preform 58, 70 contains silica soot, previously consolidated glass, or a combination thereof, the temperature of that portion of the preform must be sufficiently high wherein that part of the preform is soft enough to enable the centerline hole 60 in that region to expand under the influence of the pressurizing gas(es) in accordance with the method disclosed herein.

If the part of the preform 58, 70 where it is desired to expand the centerline hole 60 region is not high enough in temperature, the portion of the preform around that part of the preform must be heated. On the other hand, if that portion of the preform has already been heated, and the temperature of that part of the preform is sufficiently high wherein that part of the preform is soft enough to enable the centerline hole 60 in that region to expand under the influence of the pressurizing gas(es), then no additional heating is necessary in that portion.

At least part of the preform 58, 70 may consolidate while at least a portion of the preform is heated. At least a portion of the preform 58, 70 may preferably be heated while the centerline hole 60 is being (actively) pressurized. On the other hand, at least a portion of the preform 58 might not need be heated while the centerline hole is being (actively) pressurized.

If the preform is being traversed through a hot zone in a furnace which substantially locally heats a portion of the preform, then the remainder of the preform might not be so heated. Alternately, the furnace may be provided with additional hot zones such that the preform 58 can be advanced into the furnace sufficiently to be in proximity to the one or more additional hot zones.

As used herein, a plurality of hot zones or heated zones may also correspond to a plurality of furnaces, whether arranged adjacent to, or in proximity to, each other such that a single preform may be heated by the plurality of furnaces.

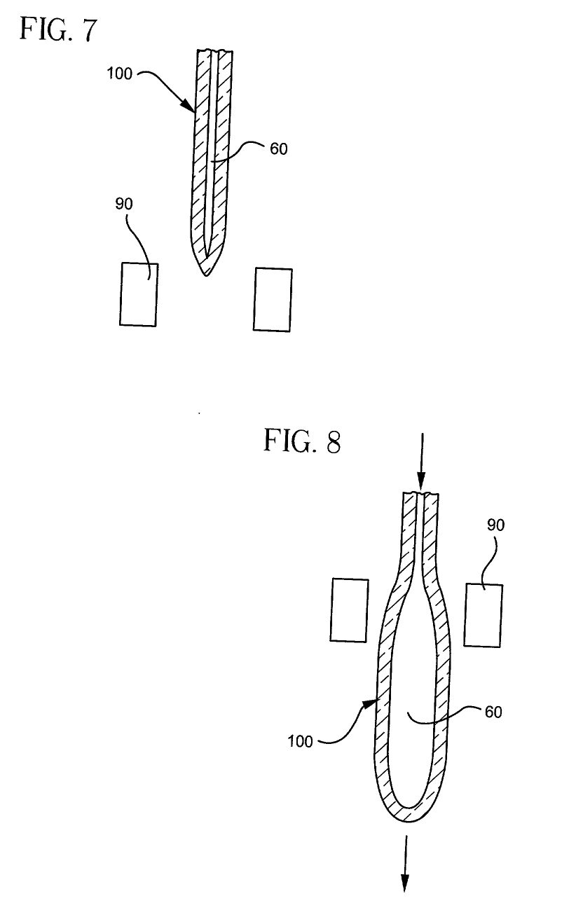

FIG. 7 schematically illustrates a silica-based 100 preform having a centerline hole 60 before entering a hot zone 90 within a furnace 64. The hot zone may be the first hot zone in a particular furnace. The preform may be a previously consolidated glass preform 55 which may have been consolidated in the same furnace or a different furnace, and/or at an earlier time. On the other hand, the preform 100 may be a soot preform 58, or a preform 58 which comprises both consolidated glass and silica-based soot, wherein it is desired to completely consolidate at least a portion of the preform during its traverse through the hot zone, as illustrated in FIG. 7. Thus, before entering the hot zone illustrated in FIG. 7, the silica-based preform 100, or the end of the preform about to enter the hot zone, may be at a temperature below, even substantially below, its consolidation temperature. For example, the silica-based preform 100 may have been consolidated then allowed to cool, say, to room temperature, or to a holding temperature which may be, for example, between room temperature and the consolidation temperature. On the other hand, the temperature of the silica-based preform 100, or the end of the preform, may be at or above its consolidation temperature. For example, the preform 100, such as in the form of glassy preform 55, may have just been consolidated in the same furnace or a different furnace.

Before, and/or during, and/or after the preform 100 enters the hot zone, a gas, or a plurality of gases, is forcibly introduced into the centerline hole region of the preform 100 to increase the pressure therein to a positive pressure with respect to the pressure at the outer surface of the preform, and in particular with respect to the pressure at the outer surface of the preform which is being expanded.

FIG. 8 schematically shows the centerline hole 60 of the preform 100 being expanded. Positive pressure is preferably maintained as the preform 100 proceeds through the hot zone 90, thereby causing the inner surface (and inside diameter) of the preform to expand. The outer surface (and outside diameter) of the preform expands as well.

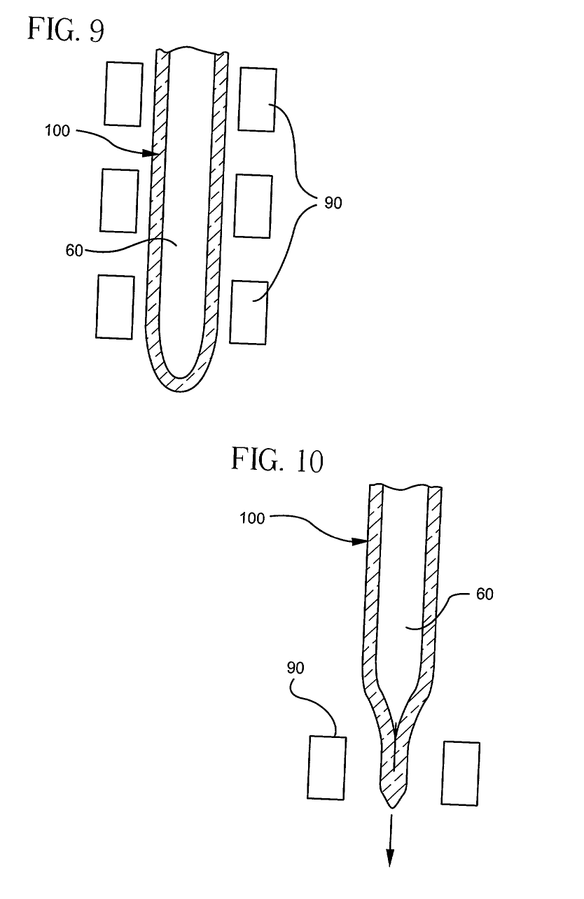

FIG. 9 schematically shows a furnace 64 having a plurality of hot zones 90, wherein the centerline hole region of substantially all of the preform 100 has been expanded. A plurality of hot zones may be desirable, or necessary, in order to raise or maintain the temperature of the portion, or portions, of interest in the preform. The skilled artisan will recognize that factors such as the traverse rate of the preform, the dimensions and composition of the preform, the heat energy available from a hot zone, including the heat exchange with the surrounding environment within the furnace, may all contribute to the determination of either the desirability or the necessity of having more than one hot zone.

The preform 100, preferably fully consolidated and having an expanded centerline hole, can then be further processed, either into an optical fiber perform 70 or, eventually, into optical fiber. Additionally, the preform 100 may either be immediately further processed or stored for future processing.

The preform 100 may, at some point, undergo the addition of one or more silica-based layers. Thus, one or more additional soot layers may be laid on the preform, such that the preform may be subjected to one or more additional consolidation steps. In addition, or in the alternative, the consolidated preform may be placed inside a glass tube, which may or may not then be provided with one or more additional layers of silica-based layers.

The centerline hole 60 is preferably fully closed or fully collapsed prior to, or during, the drawing of the preform 100 into optical fiber. Full collapse of the centerline hole 60 may be advantageously assisted by evacuating the centerline hole. A vacuum can be advantageously applied when the preform, or a portion thereof, is sufficiently soft to allow the centerline region of the preform to collapse upon itself. The centerline hole 60 may preferably be collapsed after consolidation of a soot preform 58 and expansion of the inside diameter of that preform. The skilled artisan will recognize that the strength of the vacuum, the duration for which the vacuum is applied, and the heating of the preform may all contribute to the degree of hole circularity upon complete collapse.

In accordance with the method disclosed herein, the deleterious effects of fully closing the centerline hole 60 with the assistance of a vacuum can be mitigated with a preform whose centerline hole 60 has undergone expansion, and preferably a sufficient amount of expansion as provided by an active pressurization scheme.

If the preform 100 has a sufficient ratio of outside diameter to inside diameter and if the preform is raised to a high enough temperature, the centerline region of the preform may collapse upon itself due to the effect of surface tension without the assistance of vacuum, and/or without the assistance of pulling or drawing upon one or more ends of the preform.

On the other hand, if the ratio of the outside diameter to inside diameter of the preform is relatively small, the application of a vacuum to the centerline hole, and/or the application of a pulling force on one or more ends of the preform may be desirable (e.g. to increase the speed of hole closure) or may even be necessary to close the hole. For example, the centerline hole 60 of a preform 100 in the form of a core cane preform 55 of typical dimensions would typically not fully close without the assistance of vacuum. The deleterious effects of solely applying a vacuum to close a centerline hole can thus be mitigated according to the method disclosed herein by first expanding the centerline hole region, then followed by subjecting the centerline hole to a vacuum.

FIG. 10 schematically represents a silica-based preform 100 in the form of a consolidated preform 55 having a previously expanded centerline hole 60. The preform 55 is brought into proximity with a hot zone or heated section of a furnace. A vacuum is applied to the centerline hole 60 before and/or during the traverse of the preform 55 past the hot zone in order to assist in the full closing or full collapse of the centerline hole. Thus, for example, the preform 55 represented in FIG. 10 may be a core cane preform with a centerline hole 60 being formed into a core cane (without a centerline hole). Moreover, one or more ends of the preform 55 may be pulled to draw the preform and assist in the collapse of the centerline hole 60. The drawing action may be provided in addition to, or in lieu of, evacuating the centerline hole 60.

Preferably, the centerline hole should be protected from an ambient atmosphere which might otherwise contaminate and/or re-wet the preform from (e.g. with water molecules or OH⁻ ions), and in particular the inner surface and the region surrounding the centerline hole 60, especially if it is desired that the optical fiber which is ultimately drawn from the preform should have relatively low attenuation values in the operating region(s) of interest. Such centerline hole protection is especially important, for example, when operating at or near the so-called “water peak” around 1380-1390 nm.

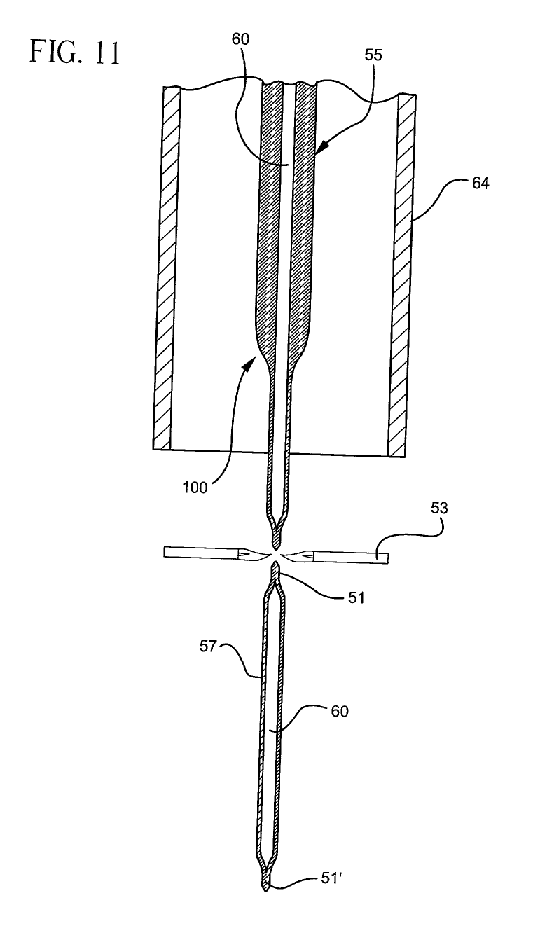

Thus, the end of the centerline hole 60 which is opposite the sealed end may preferably be sealed, at least temporarily, until the centerline hole 60 is finally fully collapsed. For example, as illustrated in FIG. 11, during a core cane redraw operation wherein at least one end of the consolidated glassy preform or core cane preform 55 is pulled from at least part of the preform that is softened, the ends, 51 and/or 51′, of the core cane 57 may preferably be sealed shut, such as with torches 53, as they are separated from the rest of the core cane preform 55. The redraw operation may be preferably carried out by a plurality of torches or dry heat sources or hot zones, (e.g. electric resistance furnaces) which heat the preform, preferably in a symmetric fashion, as the hollow core cane 55 is being drawn, and an appropriate seal may be imparted, for example by flaming shut or crimping shut the semi-molten ends of the core cane as each core cane is being separated from the preform. A plug may also be inserted into one or both ends of the core cane to seal a respective end of the centerline hole 60. A relatively thin-walled and/or hollow plug may be utilized as a plug, wherein a portion of the plug may be cut or broken or generally unsealed when desired to allow the application of a vacuum to the centerline hole.

The centerline hole 60 may be preferably sealed after the preform 100 containing at least some silica-based soot has been chemically dried. Furthermore, sealing of the centerline hole 60 may be preferable when the preform 100 will be set aside or stored for some time, rather than being immediately further processed.

The magnitude of the pressurization and the temperature of the preform govern the rate at which the centerline hole region grows and circularizes. Increasing the temperature of the preform can reduce the time needed to reach a desired hole size, and/or circularity or symmetry. Furthermore, for a given pressurization and temperature, the time required to achieve a desired hole size, and/or circularity or symmetry, depends upon the initial non-circularity or non-symmetry of the centerline hole region.

After the centerline hole region has been expanded to improve its circularity or symmetry, the hole 60 may be collapsed by applying a vacuum to the hole which leads to collapse or full closure.

In one preferred embodiment, both the pressurization and the evacuation are performed on the perform 100 while the preform is dispersed on the same consolidation furnace.

In an alternate embodiment, pressurization may occur in one location, e.g. at the consolidation furnace, and hole closure may occur in a second location, e.g. in a redraw furnace. Thus, a cane 53 with a centerline hole 60 may be introduced into a redraw furnace. Axial pulling on the preform during redraw can preferably provide a means for controlling diameter. Thereafter, the consolidated, redrawn core cane can be introduced into the same redraw furnace a second time, or the core cane can be introduced into a second redraw furnace, during which time a vacuum could be applied to the centerline hole, thereby closing the centerline hole via vacuum, surface tension, and pulling.

While several variations to the method disclosed herein have been described, the specific embodiments are not intended to be limiting, but merely exemplary of the sequential steps possible.

For example, in another aspect, the method disclosed herein comprises a fiber draw step, wherein the glass preform 70 may be drawn into optical fiber 30 (FIG. 2), wherein the centerline hole 60 of glass preform 70 closes during the fiber drawing step. As the glass preform 70 is drawn into optical fiber 30, the outside diameter of the glass preform 70 gradually reduces. Because the outside diameter of the preform is sufficiently large with respect to the inside diameter of the hole to be closed, the forces internal to the glass preform generated by this reduction on the outside diameter of the glass preform 70 cause centerline hole 60 to close as well. Surface tension forces during the fiber draw step usually differ from the vacuum forces typically needed during redraw in conventional optical fiber manufacturing techniques or in tube collapse in MCVD or IV plasma processes. Typically in glass preforms 70 which are manufactured entirely by an OVD process, the glass preform 70 may be as wide as 7 to 15 cm, and the inside diameter of centerline hole 60 between 1 to 10 mm. Consequently, the reduction in outside diameter of the fiber preform, which may range, for example from 7 to 15 cm, down to the outside diameter of a typical optical waveguide fiber (e.g., 125 microns) creates adequate forces due to the surface tensions and capillary forces involved in the reduction of the outside diameter, so that the centerline hole 60 closes completely during the draw operation without having to resort to the use of any significant vacuum.

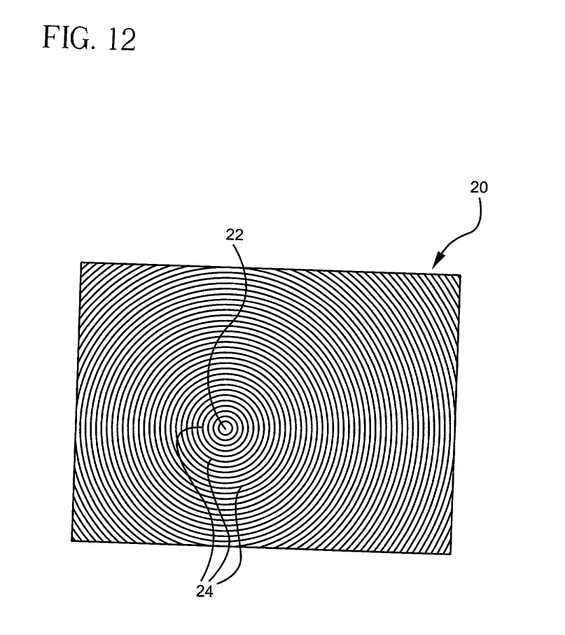

FIG. 12 schematically illustrates a cross-section of a center region of an optical fiber preform or an optical fiber, indicated generally at 20, which includes a center point 22 surrounded by symmetrically shaped layers of glass 24. This symmetric centerline profile decreases polarization mode dispersion in single mode fibers and greatly facilitates the ability to fabricate the appropriate index profile to yield high bandwidth in multimode fibers by enabling the profile in the centerline region to be tuned to a desired refractive index profile.

Thus, FIG. 12 represents a centerline profile, a cross section of an optical fiber preform for an optical fiber, or the optical fiber itself, in accordance with the method disclosed herein, wherein the centerline profile 20 has a substantially circular symmetry about centerline 22. The same uniformity or symmetry present in the preform should also be essentially preserved after being drawn into optical fiber. In addition, similar results can be achieved on single mode as well as multimode fiber core canes and the resultant optical fibers drawn therefrom. Furthermore, the circular symmetry would extend along the entire length of an optical fiber whose preform was processed in accordance with the method disclosed herein.

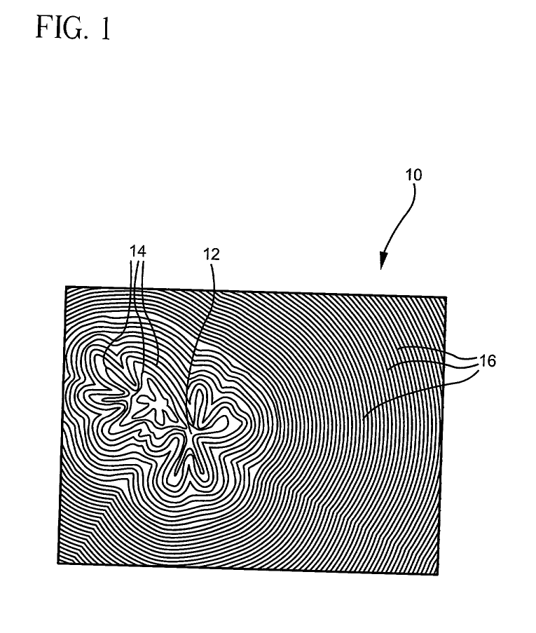

Comparing the centerline profile of a fiber produced by the subject method, as shown in FIG. 12, to the centerline profile of a fiber produced by a conventional method, as shown in FIG. 1, the centerline profile of the conventionally-manufactured fibers do not exhibit such uniform symmetry and concentricity of layers. Conversely, the fiber made in accordance with the method disclosed herein exhibits concentric and symmetric regions of glass about its centerline. In particular, circularity of the layers is preferably improved with the method disclosed herein.

Thus, the method disclosed herein may assist in achieving low levels of polarization mode dispersion without heavily depending upon or, without having to resort to, spinning techniques during the fiber draw step 130.

Multimode fiber can be manufactured using the same process as disclosed above with respect to single mode fiber manufacture. However, during the redraw and cladding deposition steps, the multimode core soot preform may not need to be closed at both ends, because attenuation may not be as critical in multimode fibers. However, the centerline hole preferably is closed as is the case with single mode fiber described above. For multimode fiber, symmetric hole closure enables the centerline region of the fiber refractive index profile to be tuned to a desired, accurate profile shape. This enables better on center bandwidth when the resultant fiber is employed with the small spot sizes exhibited by laser sources.

The methods disclosed herein can be employed not only to close a centerline hole 60 during consolidation, but also other holes during a separate diameter reducing step, e.g., a redraw step to make core cane or a draw step to make optical fiber. If the ratio of the outside diameter of the preform to the diameter of the hole present in the preform is sufficiently large, forces can be generated, by reducing the outside diameter of the preform, which are sufficient to close the centerline hole. Thus, if the outside diameter of the preform is sufficiently large, a hole within the preform can be closed during a diameter reduction operation, without having to utilize significant vacuum forces. In this way, circular and/or symmetric hole closure can be enhanced.

Also, while the method disclosed herein has been disclosed herein largely with respect to the closing of centerline holes, the methods disclosed herein are not limited to closing centerline holes, and can be used to close virtually any void present along the length of an optical fiber preform or other intermediate glass articles for use in the manufacture of optical fiber. This includes voids that would be formed as a result of rod-in-tube manufacturing techniques, as well as voids formed by assembling a glass sleeve over pre-manufactured core blanks or canes.

Additional advantages and modifications will readily occur to those skilled in the art. Therefore, the method disclosed herein in its broader aspects is not limited to the specific details, and representative devices, shown and described herein. Accordingly, various modifications may be made to the method and preform disclosed herein without departing the spirit or scope of the general inventive concept as defined by the appended claims.

What is claimed is:

1. A method of manufacturing an optical fiber, comprising:
providing a silica-based preform having an outer surface with an outside diameter and an inner surface with an inside diameter, the inner surface defining a centerline hole therein;
heating at least a portion of the preform so that at least part of the preform reaches a temperature greater than or equal to its consolidation temperature; and
pressurizing the centerline hole to a positive pressure with respect to the pressure at the outer surface of the preform by introducing at least one gas into the centerline hole sufficient to expand the inside diameter of the preform at or near the at least part of the preform while the at least part of the preform is greater than or equal to its consolidation temperature, thereby radially expanding at least part of the centerline hole.

2. The method according to claim 1 wherein the at least a portion of the preform is heated to a temperature greater than or equal to its consolidation temperature and less than its drawing temperature.

3. The method according to claim 1 wherein the at least part of the preform reaches a temperature in the range of about 1450° C. to about 1950° C.

4. The method according to claim 1 wherein the at least part of the preform reaches a temperature in the range of about 1500° C. to about 1600° C.

5. The method according to claim 1 wherein substantially all of the preform is heated simultaneously.

6. The method according to claim 1 wherein the at least a portion of the preform is heated while the centerline hole is being pressurized.

7. The method according to claim 1 wherein the at least a portion of the preform is not being heated while the centerline hole is being pressurized.

8. The method according to claim 1 wherein the centerline hole is pressurized after the at least a portion of the preform is heated.

9. The method according to claim 1 further comprising contracting the centerline hole after the centerline hole is pressurized.

10. The method according to claim 9 wherein the centerline hole at least partially contracts.

11. The method according to claim 9 wherein the centerline hole fully collapses.

12. The method according to claim 9 further comprising evacuating the centerline hole.

13. The method according to claim 12 wherein the centerline hole is evacuated without pulling on the preform.

14. The method according to claim 9 further comprising pulling on at least one end of the preform.

15. The method according to claim 14 wherein core cane is drawn from the preform.

16. The method according to claim 14 wherein optical fiber is drawn from the preform.

17. The method according to claim 14 further comprising simultaneously evacuating the centerline hole and pulling on at least one end of the preform.

18. The method according to claim 14 further comprising pulling on at least one end of the preform while the pressure in the centerline hole is at or near the pressure at the outer surface of the preform.

19. The method according to claim 1 wherein the pressure inside the centerline hole is increased by greater than about 0.1 atm above the pressure at the outer surface of the preform.

20. The method according to claim 1 wherein the pressure inside the centerline hole is increased by greater than about 0.25 atm above the pressure at the outer surface of the preform.

21. The method according to claim 1 wherein the pressure inside the centerline hole is increased by greater than about 0.5 atm above the pressure at the outer surface of the preform.

22. The method according to claim 1 wherein the pressure inside the centerline hole is increased by greater than about 1.0 atm above the pressure at the outer surface of the preform.

23. The method according to claim 1 further comprising pressurizing the centerline hole for a time sufficient to achieve a desired circularity of the centerline hole.

24. The method according to claim 1 further comprising pressurizing the centerline hole for a time sufficient to achieve a desired level of polarization mode dispersion in a fiber drawn from the preform.

25. The method according to claim 1 further comprising pressurizing the centerline hole for up to 1.5 hours.

26. The method according to claim 1 further comprising pressurizing the centerline hole for greater than about 2.0 hours.

27. The method according to claim 1 further comprising sealing at least one end of the centerline hole prior to pressurizing the centerline hole.

28. The method according to claim 1 wherein the centerline hole is actively pressurized.

29. The method according to claim 39 wherein pressurization of the centerline hole is controlled.

30. The method according to claim 1 wherein the initially provided silica based preform comprises at least one of silica-based soot and consolidated glass.

31. The method according to claim 1 wherein the initially provided silica based preform comprises a glass tube.
